(19) United States
(12) Patent Application Publication
(10) Pub. No.: US 2026/0022004 A1
(43) Pub. Date: Jan. 22, 2026

(54) ICE MAKER AND ERROR DISPLAY METHOD OF IT

(71) Applicant: BLUENIX Co., Ltd., Ansan-si, Gyeonggi-do (KR)

(72) Inventor: Doo Ha KIM, Incheon (KR)

(73) Assignee: BLUENIX Co., Ltd., Ansan-si, Gyeonggi-do (KR)

(21) Appl. No.: 18/940,806

(22) Filed: Nov. 7, 2024

(30) Foreign Application Priority Data
Jul. 19, 2024 (KR) 10-2024-0095869

(51) Int. Cl. B67D 1/08; F25C 5/20

(52) U.S. Cl. CPC B67D 1/0888; F25C 5/24; F25C 2600/04; F25C 2700/04

(57) ABSTRACT

The present disclosure provides an ice maker displaying an error through blinking of a lamp and an error display method thereof, and the ice maker may include: a case; a cooling unit provided in the case and configured to generate and store ice by heat exchange with a refrigerant; a driver provided in the case and connected to the cooling unit; a discharge unit provided to protrude outwardly of the case and including an ice discharge port for discharging generated ice and a purified water discharge port for discharging purified water supplied from a purified water supply portion.

### CROSS-REFERENCE TO RELATED APPLICATION(S)

This application claims benefit of priority to Korean Patent Application No. 10-2024-0095869 filed on Jul. 19, 2024, in the Korean Intellectual Property Office, the disclosure of which is incorporated herein by reference in its entirety.

### BACKGROUND

### 1. Field

The present disclosure relates to an ice maker and an error display method thereof.

### 2. Description of Related Art

An ice maker is a device that manufactures ice and supplies the ice to users.

Generally, an ice maker includes cold refrigerant flowing through a refrigerant pipe on an outer wall of a cylinder, freezes water inside the cylinder, and generates thin ice on an inner wall of the cylinder, and then scraps off the ice generated at this time by an auger rotating and transfers the scraped ice to an upper portion of the ice maker, thus compressing and cutting the ice. Then, the generated ice blocks are delivered to a storage tank and stored.

Meanwhile, unlike general kitchen appliances (commercial refrigerators, dishwashers, and the like), an ice maker does not commonly perform an operation process of setting an internal temperature or adjusting the control time during ice-making operation, so that only a switch for discharging water or ice is provided. Specifically, because a counter-top type ice maker does not have an external controller, it is difficult to easily identify the type of defect. For example, in the case of a product with a controller on the outside of a product, each error is displayed as E01, E02, or the like, so that the user may identify the type of defect, and based thereon, A/S, or the like, may be easily performed. However, there may be a problem that the counter-top type ice maker has no manner to identify the type of defect and makes it to respond to A/S.
(Patent Document) KR 10-1999-0061278 A

### SUMMARY

The present disclosure is to solve the above-described problem, and to provide an ice maker displaying an error through blinking of a lamp and an error display method thereof.

In order to achieve the above-mentioned purpose, the present disclosure provides an ice maker and an error display method thereof as follows.

In an embodiment of the present disclosure, an ice maker may include: a case; a cooling unit provided in the case and configured to generate and store ice by heat exchange with a refrigerant; a driver provided in the case and connected to the cooling unit; a discharge unit provided to protrude outwardly of the case and including an ice discharge port for discharging generated ice and a purified water discharge port for discharging purified water supplied from a purified water supply portion; and an input unit provided on one surface of the case and including a first input button provided to discharge the ice according to an input of a user and a second input button provided to discharge the purified water, the first input button and the second input button include a light source thereinside so as to blink.

In an embodiment, the ice maker may further include: a sensor unit connected to the cooling unit, the driver, and the discharge unit, and sensing an occurrence of an error; and a controller configured to receive information on the error from the sensor unit, classify an error mode, and control the input unit according to the error mode, and the controller may blink at least one of the first input button and the second input button according to the error mode.

In an embodiment, the controller may continue to blink at least one of the first input button and the second input button until the error is released.

In an embodiment, the controller may provide a warning sound together with a blink of at least one of the first input button and the second input button, but may stop providing the warning sound by re-input of the first input button.

In an embodiment, a method for displaying an error using the ice maker described in claim 4 may include: an error sensing operation of sensing an error of the ice maker by the sensor unit; an error classification operation of classifying an error mode according to information on the error received from the sensor unit by the controller; and an error display operation of blinking at least one of the first input button and the second input button according to the error mode by the controller.

In an embodiment, in the error display operation, a blinking interval and the number of blinks of the first input button and the second input button may be different according to the error mode classified in the error classification operation.

In an embodiment, in the error classification operation, when the sensor unit senses a temperature error of the cooling unit, the controller may classify the error mode as a first error mode, and in the error display operation, the controller may blink the first input button and the second input button simultaneously according to the first error mode.

In an embodiment, in the error classification operation, when the sensor unit senses an error in an ice-making water level of the cooling unit, the controller may classify the error mode into a second error mode, and in the error display operation, the controller may alternately blink the first input button and the second input button according to the second error mode.

In an embodiment, in the error classification operation, when the sensor unit senses an error in the driver, the controller may classify the error mode into a third error mode, and in the error display operation, the controller may blink the first input button at a preset blinking interval and the number of blinks according to the third error mode.

In an embodiment, in the error classification operation, when the sensor unit senses an error in the discharge unit, the controller may classify the error mode into the fourth error mode, and in the error display operation, the controller may blink the second input button at a preset blinking interval and the number of blinks according to the fourth error mode.

According to an embodiment of the present disclosure, it may be possible to provide an ice maker for displaying an error of an ice maker through blinking of a lamp and an error display method thereof.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of an ice maker according to an embodiment of the present disclosure when viewed from the outside;

FIG. 2 is a schematic conceptual diagram illustrating a configuration of an ice maker according to an embodiment of the present disclosure;

FIG. 3 is a plan view illustrating a display unit according to an embodiment of the present disclosure;

FIG. 4 is a flowchart of an error display method according to an embodiment of the present disclosure;

FIG. 5 is a use state diagram of a display unit according to a first error mode;

FIG. 6 is a usage state diagram of a display unit according to a second error mode;

FIG. 7 is a usage state diagram of a display unit according to a third error mode; and

FIG. 8 is a usage state diagram of a display unit according to a fourth error mode.

### DETAILED DESCRIPTION

Hereinafter, detailed embodiments will be described in detail with reference to the accompanying drawings. However, the concept of the present disclosure is not limited to proposed embodiments of the present disclosure, and other regressive inventions or other embodiments included in the scope of the spirits of the present disclosure may be easily proposed through addition, change, deletion, and the like of other elements, but should be construed as being included in the scope of the present disclosure.

Furthermore, throughout the specification, the terms “connected to” or “coupled to” are used to designate a connection or coupling of one element to another element and include both a case where an element is “directly connected or coupled to” another element and a case where an element is “indirectly connected or coupled to” another element via still another element. Furthermore, when a certain portion “includes” or “comprises” a certain component, this indicates that other components are not excluded and may be further included unless otherwise noted.

Furthermore, components with the same function within the same range of ideas indicative of the drawings of each embodiment are described using the same reference numerals.

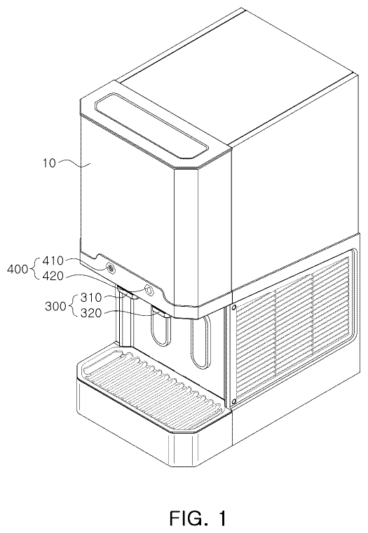

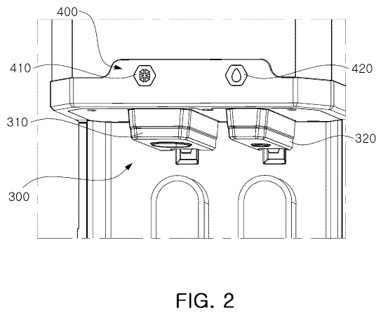

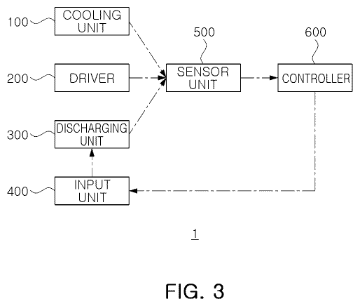

FIGS. 1 to 3 illustrate an ice maker 1 according to an embodiment of the present disclosure. More specifically, FIG. 1 is a perspective view of an ice maker 1 according to an embodiment of the present disclosure when viewed from the outside, FIG. 2 is a schematic conceptual diagram illustration the configuration of an ice maker 1 according to an embodiment of the present disclosure, FIG. 3 is a plan view illustrating an input unit 400 according to an embodiment of the present disclosure. Hereinafter, an ice maker 1 according to an embodiment of the present disclosure will be described with reference to FIGS. 1 to 3.

As illustrated in FIG. 1, an ice maker 1 according to an embodiment of the present disclosure may include a case 10, a cooling unit 100 provided in the case 10 and configured to generate and store ice by heat exchange with a refrigerant, a driver 200 provided in the case 10 and connected to the cooling unit 100, a discharge unit 300 provided to protrude outwardly of the case 10 and discharging purified water or ice supplied from a purified water supply portion (not illustrated), and an input unit 400 provided on one surface of the case 10 and configured to discharge the purified water or the ice according to an input of a user. In this case, the purified water supply portion (not illustrated) may be provided to be connected to the ice maker 1, and may be provided on the outside of the case 10 to supply drinking purified water by passing through a pipe (not illustrated) connected to the discharge unit 300 and a filter member (not illustrated) connected to the pipe (not illustrated). However, the purified water supply portion (not illustrated) may have any position and structure as long as this may supply drinking purified water toward the discharge unit 300, more specifically, toward a purified water discharge port 320 described below, and the position and structure are not limited thereto.

More specifically, the discharge unit 300 may include an ice discharge port 310 for discharging ice generated in the cooling unit 100 and the purified water discharge port 320 for discharging purified water supplied from the purified water supply portion (not illustrated), and the ice discharge port 310 and the purified water discharge port 320 may be provided separately and spaced apart from each other. In this case, the input unit 400 includes a first input button 410 for discharging ice according to an input and a second input button 420 for discharging purified water. That is, when a user presses the first input button 410, the ice maker 1 according to an embodiment of the present disclosure discharges ice through the ice discharge port 310, and when the second input button 420 is pressed, the ice maker 1 may discharge purified water through the purified water discharge port 320. In this case, the first input button 410 and the second input button 420 may include a light source (not illustrated) inside so as to blink, and for example, an LED element may be included therein. Accordingly, the ice maker 1 according to an embodiment of the present disclosure may display the first input button 410 and the second input button 420 by the light source (not illustrated) during operation, so that users may input and discharge ice and purified water separately.

Furthermore, the ice maker 1 according to an embodiment of the present disclosure may further include a sensor unit 500 connected to the cooling unit 100, the driver 200 and the dispensing unit 300, and sensing an occurrence of an error, and a controller 600 receiving information on the error from the sensor unit 500 to classify an error mode and control the input unit 400 according to the error mode. In this case, the controller 600 may blink at least one of the first input button 410 and the second input button 420 according to the error mode.

Accordingly, according to the ice maker 1 according to an embodiment of the present disclosure, the first input button 410 and the second input button 420 for discharging purified water or ice may sense an error of the ice maker 1 and display the error, so that the user may easily confirm the type of defect without a separate display device and shorten the A/S time.

Additionally, according to the ice maker 1 according to an embodiment of the present disclosure, the controller 600 may continue to blink at least one of the first input button 410 and the second input button 420 until the error is released. Accordingly, when the error of the ice maker 1 is not completely released, since the error may be continuously displayed to the user by the controller 600, it may easy to respond to defects in a product.

Additionally, the ice maker 1 according to an embodiment of the present disclosure may provide a warning sound together with the blinking of the first input button 410 and the second input button 420 by the controller 600. In this case, the controller 600 may stop providing the warning sound by re-input of the first input button 410. That is, unlike the blinking of the first input button 410 and the second input button 420, the ice maker 1 according to an embodiment of the present disclosure may provide a warning sound to cause inconvenience to the user, so that the warning sound may be released by re-inputting the first input button. In the specification of the present disclosure, the re-input of the first input button 410 may refer to an input after the controller 600 blinks one of the first input button 410 and the second input button 420 due to the occurrence of the error.

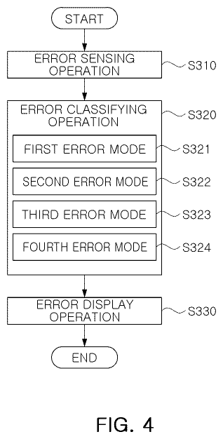

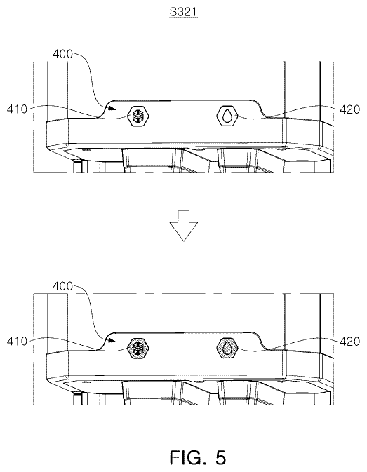

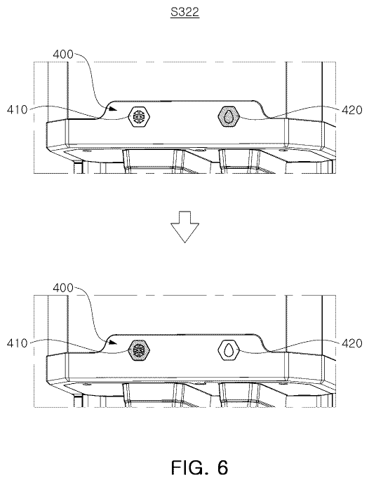

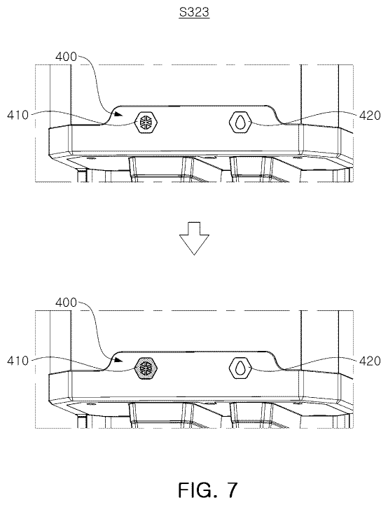

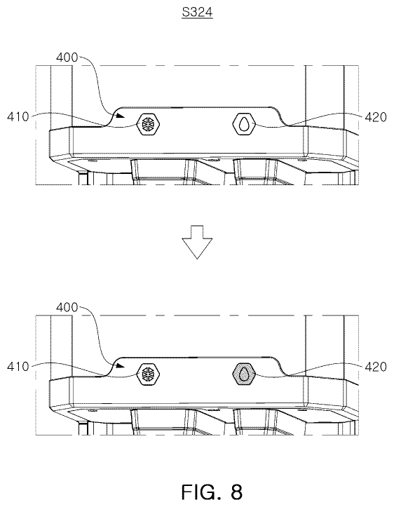

FIGS. 4 to 8 illustrate an error display method according to an embodiment of the present disclosure. More specifically, FIG. 4 is a flowchart of an error display method according to an embodiment of the present disclosure, FIG. 5 illustrates a display unit blinking method according to a first error mode, FIG. 6 illustrates a display unit blinking method according to a second error mode, FIG. 7 illustrates a display unit blinking method according to a third error mode, and FIG. 8 illustrates a display unit blinking method according to a fourth error mode.

Hereinafter, reference will be made to FIGS. 4 to 8, but since an error display method according to an embodiment of the present disclosure may be performed by the ice maker 1 according to an embodiment of the present disclosure, this will be described with reference to FIGS. 1 and 3 together.

An error display method according to an embodiment of the present disclosure includes: an error sensing operation (S310) of sensing an error in the ice maker 1 by the sensor unit 500; an error classification operation (S320) of classifying an error mode according to information on the error received from the sensor unit 500 and transmitting the error to the input unit 400 by the controller 600; and an error display operation (S330) of blinking at least one of the first input button 410 and the second input button 420 according to the error mode by the controller 600.

In this case, in the error display operation (S330) according to an embodiment of the present disclosure, a blinking interval and the number of blinks of the first input button 410 and the second input button 420 may be different according to the error mode classified in the error classification operation (S320). In the error classification (S320), the controller 600 may classify an error mode into first to fourth error modes according to the information on the error sensed in the error sensing operation (S310), and in the error display operation (S330), the controller 600 may blink at least one of the first input button 410 and the second input button 420 depending on each error mode according to the preset blinking interval and the number of blinks.

In the error classification operation (S320), when the sensor unit 500 senses a temperature error of the cooling unit 100 from the sensor unit 500, the controller 600 may classify the error mode into a first error mode (S321). Then, in the error display operation (S330), the controller 600 may simultaneously blink the first input button 410 and the second input button 420 according to the first error mode (S321).

For example, the first error mode (S321) may include a high temperature error and a freezing error. As illustrated in FIG. 5, in the first error mode (S321), the controller 600 may blink the first input button 410 and the second input button 420 once per second, and more specifically, when the sensor unit 500 senses that the temperature of the cooling unit 100 is higher than a preset temperature, the controller 600 may classifies the error mode as a high temperature error, and the controller 600 may simultaneously blink the first input button 410 and the second input button 420 once per second. Furthermore, when the sensor unit 500 senses that the temperature of the cooling unit 100 is lower than the preset temperature, the controller 600 may classify the error mode as a freezing error of a refrigerant pipe (not illustrated) and simultaneously blink the first input button 410 and the second input button 420 twice per second.

In the error classification operation (S320), when the sensor unit 500 senses an ice-making water level error of the cooling unit 100, the controller 600 may classify the error mode as a second error mode (S322). Then, in the error display operation (S330), the controller 600 may alternately blink the first input button 410 and the second input button 420 according to the second error mode (S322).

For example, the second error mode (S322) may include a low water level error. More specifically, the sensor unit 500 may sense a low water level of an ice-making water storage tank (not illustrated) through a water level sensor (not illustrated) provided in the ice-making water storage tank (not illustrated) in which the ice-making water is stored, and when the sensor unit 500 senses a low water level error of the ice-making water, the controller 600 may classify the error mode as the second error mode (S322). Furthermore, the controller 600 may sequentially blink the first input button 410 and the second input button 420 once per second according to the second error mode (S322).

In the error classification operation (S320), when the sensor unit 500 senses an error of the driver 200, the controller 600 may classify the error as a third error mode (S323). Then, in the error display operation (S330), the controller 600 may blink the first input button 410 at a preset blinking interval and the number of blinks according to the third error mode (S323).

For example, the third error mode (S323) may include an error of the driver 200. More specifically, when the sensor unit (not illustrated) senses that a driving motor (not illustrated) of the driver 200 does not operate or malfunctions, the controller 600 may sense a driving error of the driver 200, and the controller 600 may classify the error mode as the third error mode (S323). Additionally, the controller 600 may blink the first input button 410 once per second according to the third error mode (S323).

In the error classification operation (S320), when the sensor unit 500 senses an error of the discharge unit 300, the controller 600 may classify the error mode as the fourth error mode (S324). Then, in the error display operation (S330), the controller 600 may blink the second input button 420 at a preset blinking interval and the number of blinks according to the fourth error mode (S324).

For example, the fourth error mode (S324) may include an error of the discharge unit 300. More specifically, the sensor unit (not illustrated) may sense an error in which the discharge unit 300 is blocked or the discharge of purified water or ice is blocked, and the controller 600 may classify the error mode as the fourth error mode (S324). Furthermore, as illustrated in FIG. 8, the controller 600 may blink the second input button 420 once per second according to the fourth error mode (S324).

Meanwhile, the error display method according to an embodiment of the present disclosure may set and display various error modes other than the first to fourth error modes S321, S322, S323 and S324) by independently setting the blinking interval and the number of blinks of the first input button 410 and the second input button 420.

In the case of conventional counter-top ice makers, since there is no need for operations such as setting an internal temperature or setting the control time during product operation, no separate controller or display unit is provided on the outside of the product. Specifically, since the counter-top ice maker includes only two input buttons, the first input button 410 for discharging ice and the second input button 420 for discharging purified water, like the ice maker 1 according to an embodiment of the present disclosure, there was a problem in that a separate display unit was not provided to indicate when a product defect occurred.

According to the error display method according to an embodiment of the present disclosure, the error of the ice maker may be displayed by the input unit 400 configured to display discharging of purified water or ice, so that the user may easily identify defects and respond thereto. Furthermore, the error display method according to an embodiment of the present disclosure may distinguish between the defects of each of the cooling unit 100, the driver 200, and the discharge unit 300, and more specifically, may distinguish between defects due to a temperature of the cooling unit 100 and defects due to the water level sensor (not illustrated), thereby allowing the user to easily identify the type of defects and shorten the A/S time.

While embodiments have been mainly described above, the present disclosure is not limited the above-described embodiments, it will be apparent to those skilled in the art that modifications and variations could be made without changing the technical idea of the present disclosure as defined by the appended claims.

What is claimed is:

1. An ice maker, comprising:
a case;
a cooling unit provided in the case and configured to generate and store ice by heat exchange with a refrigerant;
a driver provided in the case and connected to the cooling unit;
a discharge unit provided to protrude outwardly of the case and including an ice discharge port for discharging generated ice and a purified water discharge port for discharging purified water supplied from a purified water supply portion; and
an input unit provided on one surface of the case and including a first input button provided to discharge the ice according to an input of a user and a second input button provided to discharge the purified water,
wherein the first input button and the second input button include a light source thereinside so as to blink.

2. The ice maker according to claim 1, further comprising:
a sensor unit connected to the cooling unit, the driver, and the discharge unit, and sensing an occurrence of an error; and
a controller configured to receive information on the error from the sensor unit, classify an error mode, and control the input unit according to the error mode,
wherein the controller blinks at least one of the first input button and the second input button according to the error mode.

3. The ice maker according to claim 2, wherein the controller continues to blink at least one of the first input button and the second input button until the error is released.

4. The ice maker according to claim 3, wherein the controller provides a warning sound together with a blink of at least one of the first input button and the second input button, but stops providing the warning sound by re-input of the first input button.

5. A method for displaying an error using the ice maker described in claim 4, the method comprising:
an error sensing operation of sensing an error of the ice maker by the sensor unit;
an error classification operation of classifying an error mode according to information on the error received from the sensor unit by the controller; and
an error display operation of blinking at least one of the first input button and the second input button according to the error mode by the controller.

6. The method for displaying an error according to claim 5, wherein in the error display operation, a blinking interval and the number of blinks of the first input button and the second input button are different according to the error mode classified in the error classification operation.

7. The method for displaying an error according to claim 6, wherein in the error classification operation,
when the sensor unit senses a temperature error of the cooling unit, the controller classifies the error mode as a first error mode, and
in the error display operation,
the controller simultaneously blinks the first input button and the second input button according to the first error mode.

8. The method for displaying an error according to claim 7, wherein in the error classification operation,
when the sensor unit senses an error in an ice-making water level of the cooling unit, the controller classifies the error mode into a second error mode, and
in the error display operation,
the controller alternately blinks the first input button and the second input button according to the second error mode.

9. The method for displaying an error according to claim 8, wherein in the error classification operation,
when the sensor unit senses an error in the driver, the controller classifies the error mode into a third error mode, and
in the error display operation,
the controller blinks the first input button at a preset blinking interval and the number of blinks according to the third error mode.

10. The method for displaying an error according to claim 9, wherein in the error classification operation,
when the sensor unit senses an error in the discharge unit, the controller classifies the error mode into the fourth error mode, and
in the error display operation,
the controller blinks the second input button at a preset blinking interval and the number of blinks according to the fourth error mode.
